(19) United States
(12) Patent Application Publication
(10) Pub. No.: US 2010/0258974 A1
(43) Pub. Date: Oct. 14, 2010

(54) MOULDING PROCESS AND APPARATUS

(75) Inventor: Neil Edwin Wallace, New South Wales (AU)

Correspondence Address: MICHAEL BEST & FRIEDRICH LLP, 100 E WISCONSIN AVENUE, Suite 3300, MILWAUKEE, WI, 53202, US

(73) Assignee: BLUESCOPE STEEL LIMITED, Melbourne, Victoria (AU)

(21) Appl. No.: 12/745,623

(22) PCT Filed: Nov. 28, 2008
(86) PCT No.: PCT/AU2008/001769

§ 371 Date: Jul. 6, 2010

(30) Foreign Application Priority Data
Nov. 29, 2007 (AU) 2007906519

(51) Int. Cl. B32B 37/10

(52) U.S. Cl. 264/262; 425/124

(57) ABSTRACT

A mould for casting a component onto a body comprising first and second mould parts arranged to be disposed on respective ones of the opposite sides of the body. At least one of the parts defines at least a portion of a mould cavity that is in communication with the body to allow for casting of the component on to the body. The mould has particular application to direct casting of polymeric couplings on to pipe ends.

### FIELD OF THE INVENTION

The present invention relates generally to methods of making composite products, to moulding apparatus used in making those products, and to associated products. The invention has particular application to composite products that include a polymeric component that is formed on a body formed of metal. The invention is described with reference to composite products for water infrastructure (such as pipes, channels, water detention or retention systems, and tanks) that are made principally from steel strip that incorporates a corrosion resistant metal coating and in some arrangements a polymeric film overlay. However, it is to be appreciated that the invention has broader application and is not limited in that use.

### BACKGROUND OF THE INVENTION

It has been found beneficial in at least some instances to form products such as water infrastructure products, as a composite construction where a polymeric component is connected to the product body made typically from sheet metal. This component may serve a variety of purposes. For example, the component may provide a coupling to allow the product body to be connected to another coupling to form a watertight seal at the coupling. In another example, the polymeric component may be used as part of a base or lid structure for a water tank or detention/retention system.

In the applicant's earlier International application WO2007/073579 entitled “Method of Making a Composite Product”, the contents of which are herein incorporated by cross reference, there is disclosed methods for making such composite products by direct casting of the polymeric components onto the product body.

It has been realised that improvements in the mould design can assist in such direct casting processes.

### SUMMARY OF THE INVENTION

According to a first aspect, the present invention provides a mould for casting a component onto a body having opposite sides, the mould comprising first and second mould parts arranged to be disposed on respective ones of the opposite sides of the body, and at least one of the parts defining at least a portion of a mould cavity that is in communication with the body.

In the context of the specification, the term “cast” or variations such as “casting” and the like as used in relation to the polymeric components includes all moulding techniques and/or resulting articles formed by such techniques, where the polymeric material is introduced into a mould so as to form the component into a particular shape. The material may be introduced into the mould by any suitable method such as via an injection moulding process, an extruder feed arrangement, or may be formed by a rota moulding or blow moulding processes.

In one form, each of the first and second mould parts define a portion of the mould cavity.

In a particular form, the mould is arranged to provide support for the body during casting of the component. Such an arrangement is particularly suited for use with casting onto thinner materials (such as steel sheet of less than 1 mm) because it can reduce the reliance on the strength of the body during casting. However, the mould is not limited to use with such materials. For example the process may be used where the body is made of a different construction, for example from thicker sheet of strip sections (say for steel being greater than 2 mm), or from thicker walled cast or moulded components.

In a particular form, the mould is arranged to enable fluid pressure to be applied to both sides of the body so as to support the body during casting of the component. A mould according to this form is suited to be used in a process where a polymeric material is cast onto the body whilst providing fluid pressure on opposite sides of the body. In this way the total fluid pressure that can be introduced into the cavity is not dependent on the strength of the body as during casting there is some balancing of the fluid pressure on the opposite sides of the body. With this arrangement the primary force on the body is the differential in the fluid pressure on the opposite sides of the body during casting.

In one form, one of the first and second mould parts is arranged to provide a support surface for the body whilst the component is being cast on the body. In this way, the mould part provides a support surface on which the body directly, or through an intermediate component, engages to assist it in accommodating the loading induced on the body during casting.

In a particular form, the first and second mould parts are separate and are arranged to engage and when so engaged form a common cavity in which the portion of the body is arranged to be received. In another form the first and second moulded parts are connected to or integrally formed with each other so that the mould is formed as a single unit that is adapted to receive the body.

In one form, the body is a hollow section and one mould part forms an inner mould component whilst the other mould part forms an outer mould component.

In a particular form, the mould further comprises a sealing arrangement arranged to engage with the body and being operative to provide a fluid seal between the body and the mould so as to prevent moulding material introduced into the cavity to egress from the cavity.

In a second aspect, the present invention provides a mould for making composite products where a component is cast onto a body. In particular, a mould is provided for casting a component onto a body, the mould defining a mould cavity and incorporating a sealing arrangement, wherein a portion of the body is arranged in communication with the mould cavity and the sealing arrangement is arranged to engage with the body and is operative to provide a fluid seal between the body and the mould so as to prevent moulding material introduced into the cavity to egress from the cavity.

In accordance with this aspect, a sealing arrangement is provided that allows the mould to engage with the body, thereby facilitating direct casting onto the body surface. Moreover, the body does not need to be contained wholly within the mould, but may in fact project from the mould thereby giving more flexibility to moulding process and in particular making the moulding process suitable for casting onto elongate bodies, such as pipes and the like.

In one form the sealing arrangement of either aspect described above, includes a seal that is moved between a retracted and an extended condition, wherein the seal is arranged to be moved from its retracted to its extended condition to affect a fluid seal with the body. In a particular form, the mould further comprises an actuator which is operative to move the seal between its retracted and extended condition.

An advantage of this arrangement is that it provides a sealing arrangement where the seal is biased into contact with the body surface which can enhance the integrity of the resulting seal. Further, moving a seal between a retracted and an extended condition can facilitate movement of the mould into and out of engagement with the body as will be described in more detail below.

In another form, the sealing arrangement includes a seal that is deformable and is arranged to conform to the profile of the body surface when biased into contact with that surface. Such an arrangement can be advantageously used in situations where the profile of the body surface is uneven as is the case when the body is a pipe having one or more stiffening formations formed on its outer surface.

In a particular form, where the body is a hollow section (such as the pipe mentioned above) and the mould includes an inner and outer mould component, the sealing arrangement includes first and second seals disposed on respective ones of the inner and outer mould components. In one form, the body is retained (arranged to be disposed or clamped) between those seals. In a particular form, the first seal which is formed on the inner mould component is in the form of the seal described above which is able to move between a retracted and extended position.

In a particular embodiment, the second seal is disposed on the outer mould component and is in the form of a deformable seal as mentioned above. In a particular form the outer mould is in turn formed of first and second mould parts that are movable with respect to each other so as to open to allow receipt of the body portion within the mould and to close wherein the second seal is biased into contact with the body surface so as to cause that second seal to conform to the surface of the body.

In one form, the body is in the form of a pipe and wherein the inner mould component is locatable within the pipe and the outer mould component is arranged to clamp around the exterior of the pipe.

In a particular form, at least one aperture is located in the body to allow the fluid polymeric material to flow between the opposite sides so as to balance the fluid pressure being applied to the opposite sides during casting.

In a particular form, at least one spacer is disposed on the body on which at least one of the mould parts is located. In a particular form, the at least one spacer is mounted within said at least one aperture. The spacer can engage with one of the moulds, thereby providing support for the body during casting.

A mould according to the above form and the process described above is ideally suited for the casting of a polymeric component onto a sheet metal body.

In one form, the body is in the form of a pipe with a closed section. In a particular form, the pipe includes at least one external rib which extends between opposite ends of the pipe. One such pipe is formed from steel having a corrosion resistant metal coating and incorporating a polymeric film. The polymeric film not only aids in bonding of the component to the section but may be used for other purposes. For example the polymeric film may provide a moisture barrier and/or enhance the chemical resistance of the metal. Such polymeric films may include low density or high density polyethylene, PVC and polypropylene.

In one form, the body incorporates steel sheet having a thickness in the range of 0.5 mm to 1.6 mm or greater if required by specific applications.

In one form, the component is cast onto the body so as to form a coupling for that body. In one form, the coupling is formed at the end of the body. In another form, the component may be formed at an intermediate section of the body to provide an intermediate connection for that body.

In one form, the polymeric component is cast as a preform onto the body. In this way the mould cavity is shaped to form the preform. In that arrangement the process further comprises the step of post forming the preform into its finished shape. In an alternative arrangement, the mould is configured so that polymeric component is cast into its finished shape directly without requiring any post forming or machining.

Whilst the mould described is ideally suited for us in the above process, it is to be appreciated that the invention is not limited to that use. For example, the mould may be used in a process where a host body forms part of the mould and the component is cast onto a surface of the body. Such an arrangement is disclosed in the applicant's earlier International application WO 2007/073579. In such an arrangement, a part of the mould may engage with the opposite side of the body to the component is being cast on to support the body during casting.

In yet a further aspect, the invention provides a process of sealing a mould part to the surface of a body comprising the steps of: moving one or both of the mould part and the body into register with the other; and moving a seal on the mould part from a retracted position to an extended position so as to form a fluid seal between the mould part and the body.

In yet a further aspect, the invention is directed to a polymeric component formed using any form of the mould or process disclosed above.

### BRIEF DESCRIPTION OF THE DRAWINGS

Embodiments are hereinafter described with reference to the accompanying drawings. It is to be appreciated that the particularity of the drawings and the related description is to be understood as not limiting the preceding broad description of the invention.

In the drawings:

FIGS. 1A, 1B and 1C are schematic views of various pipe couplings incorporating polymeric components used in water infrastructure;

FIG. 2 is a schematic view of a branch junction for a pipe;

FIG. 3 is a schematic sectional view of a water tank incorporating a polymeric base coupling;

FIG. 4 is a schematic side view of a moulding apparatus connected to an end of a host body;

FIG. 5 is an end view of the moulding apparatus of FIG. 4;

FIG. 6 is a schematic sectional view of the moulding apparatus connected to the host body, where that section has an external ribbed configuration;

FIG. 7 is a variation of the view of FIG. 6 where the host body is corrugated;

FIG. 8 is a further variation of a pipe coupling of FIG. 1C in an exploded view;

FIG. 9 is an assembled view of the pipe coupling of FIG. 8;

FIG. 10 is a sectional view of the pipe coupling of FIG. 8;

FIG. 11 is a sectional view of a variation on the composite product incorporating a host pipe and male coupling;

FIG. 12 is a detailed view of the host pipe of the composite product of FIG. 11;

FIG. 13 is a schematic sectional view of the moulding apparatus connected to the host pipe of FIG. 12;

FIG. 14 shows a sectional view of a mould for casting a component on a host pipe in a closed position with the seal of the inner mould component in a retracted condition; and

FIG. 15 shows the mould of FIG. 14 with the seal of the inner mould component in an extended condition.

### DETAILED DESCRIPTION OF THE DRAWINGS

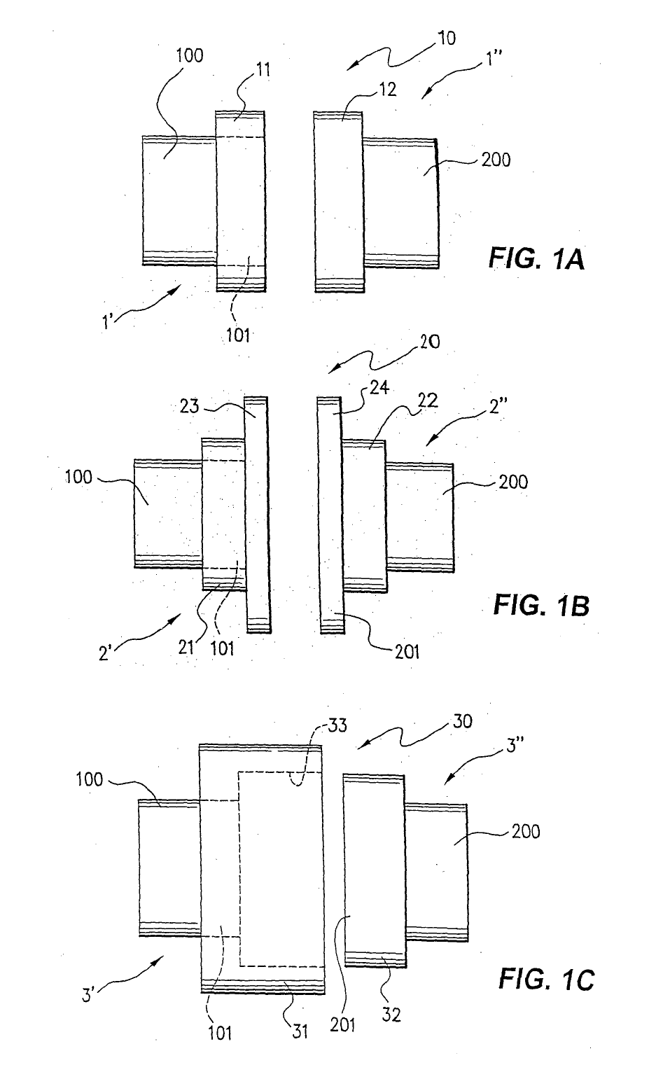

FIGS. 1A to 1C illustrate various couplings 10, 20 and 30 for connecting first and second pipes 100 and 200. The couplings incorporate polymeric components which are moulded to ends of the pipe as will be described in more detail below.

In the illustrated form, the pipes 100 and 200 are formed from sheet steel that incorporates a corrosion resistant coating. Further, the steel may be profiled to include stiffening formations so as to increase the strength of the pipe. These stiffening formations may be in the form of ribs, corrugations or the like. Furthermore, the pipes 100 and 200 may be coated with a polymeric material. This polymeric material may be in the form of a film that provides a moisture barrier and/or enhances the chemical resistance of the sheet metal. Such polymeric films may include low or high density polyethylene, PVC and polypropylene. Further, the polymeric film may facilitate bonding of the polymeric components to the respective pipes.

An example of a pipe that is formed from sheet steel strip, typically having a gauge of between 0.5 mm to 1.6 mm and which includes external ribs that extend helically along the pipe, is sold by the applicant under the trade marks HYDRORIB and AGRIRIB. This pipe incorporates an LD polyethylene film coating sold under the trade mark TRENCHCOAT™LG and is formed by a process of spiral winding the steel strip.

The pipes 100, 200 are arranged to be connected through the couplings 10, 20 and 30 in end to end relationship to provide a fluid seal so as to be able to convey fluid such as water over indefinite lengths. The infrastructure provided by the pipes 100, 200 may be pressure rated for example to supply town water, water for irrigation or gas, or may be non-pressurised and used in applications such as culverts or storm water. The efficacy of the seal formed by the couplings 10, 20 or 30 dictate largely the pressure rating of the pipes.

In the embodiment illustrated in FIG. 1A, the coupling 10 incorporates a first polymeric coupling 11 formed at the end of the first pipe 100 and a second polymeric coupling 12 formed at the end of the other pipe 200. These couplings are arranged to abut one another to form a butt connection between the pipes 100 and 200. A clamping element (not shown) may be disposed over the couplings so as to retain them in position.

In the embodiment illustrated in FIG. 1B, a first coupling 21 is formed on the pipe end 101 whereas a second coupling 22 is formed on the end 201 of the second pipe 200. Each of the couplings includes a flange (23, 24 respectively) at its outer end and these flanges are arranged to butt together in connection of the coupling 20. Whilst not shown, typically fasteners, such as nuts and bolts, extend through the flanges 23 and 24 to maintain the pipes together.

In the embodiment in FIG. 1C, the coupling 30 is of a bell and spigot type with the bell 31 being formed on the end of the pipe 100, and the spigot 32 formed on the end of the other pipe 200. Location of the spigot 32 into the cavity 33 of the bell 31 connects the pipes 100 and 200 together and affects the seal therebetween.

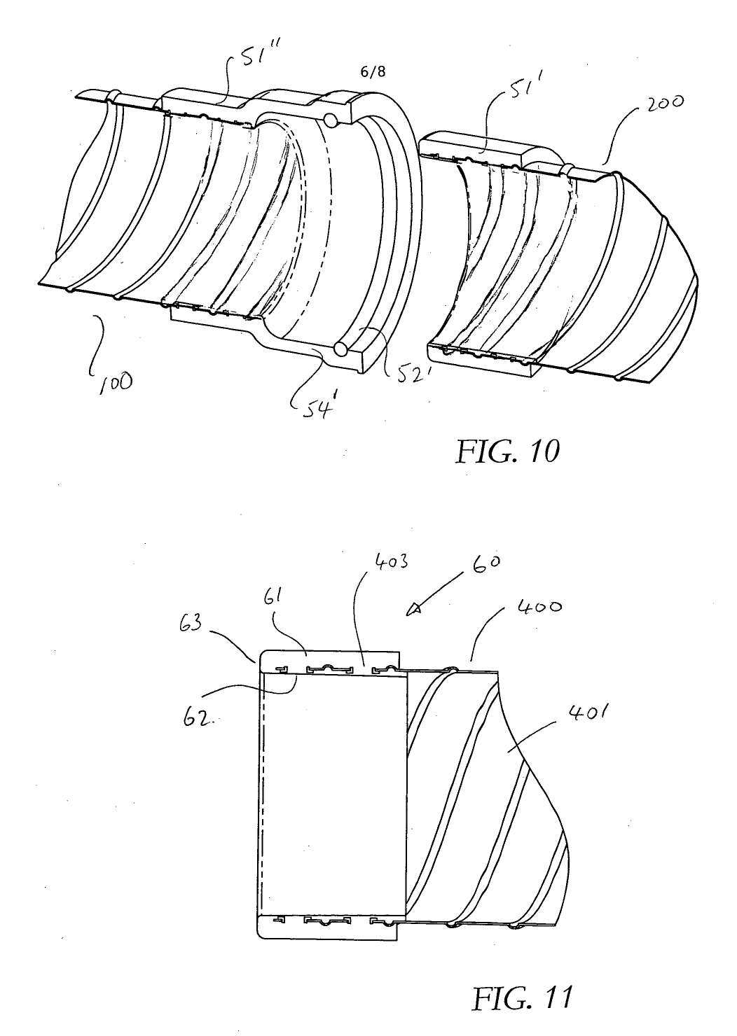

The embodiments of FIGS. 1A to 1C illustrate general coupling types which are ideally formed from polymeric components. As will be appreciated by those skilled in the art, it may be necessary to incorporate seals such as “O” ring seals or pressure seals to provide a watertight joint. An example of such an arrangement is shown in FIGS. 8 to 10.

In the embodiment of FIGS. 8 to 10, a first coupling element (bell) 50^{I} is disposed on the end of one pipe 100 and forms the female component whereas the other coupling element (spigot) 51^{II} is disposed on the end of the other pipe 200 and forms the male connection. A pressure seal 52^{I} is disposed on the female component 50^{I} and is designed to engage with an external surface 53^{II} of the male component 51^{I}. The pressure seal is set partly into a recess 54^{I} formed in an inner surface of the female component 50^{I}.

A joint that is fluid tight is formed by locating the male component 52^{II} into the bore 53^{I} of the female component 50^{I}. The pressure seal 52^{I} forms the fluid seal and is designed to move into tighter engagement with the coupling elements 50^{I} and 51^{II} under increased pressure in the pipes thereby not only increasing the seal but also inhibiting inadvertent release of the pipes. This obviates the need for any separate clamping element to keep the pipe lengths 100, 200 axially aligned.

In addition to the seal formed between the coupling elements, the effectiveness of the coupling to provide a fluid seal will depend to some extent on the interface between the respective polymeric component and the host pipe. The provision of this fluid tight interface between these parts will be described in more detail below.

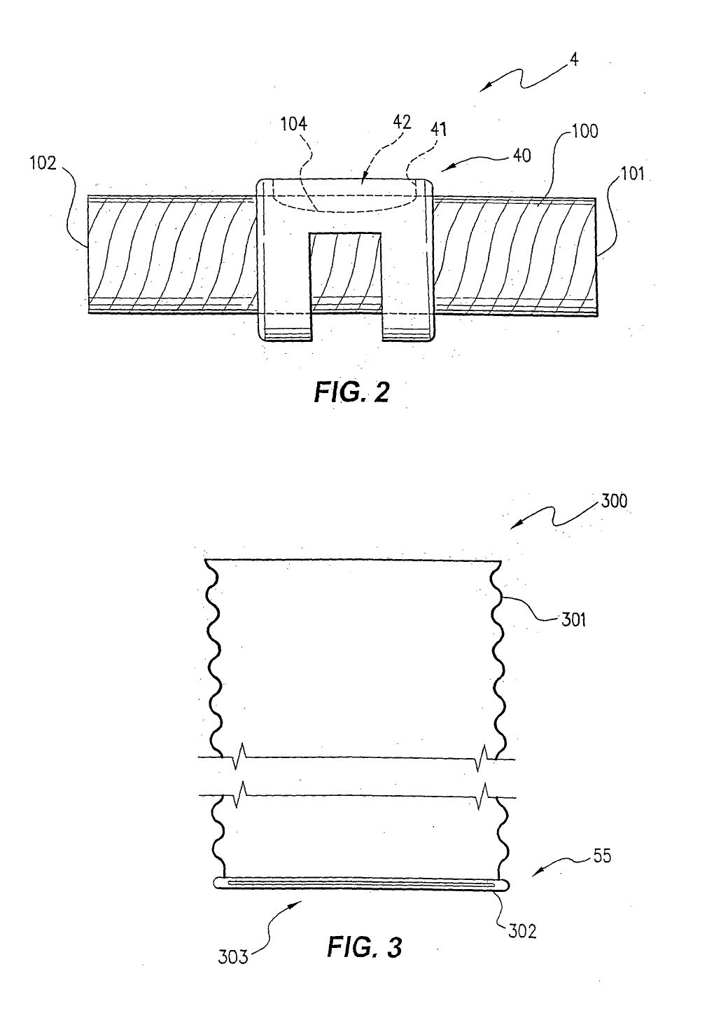

FIG. 2 illustrates a further variation of coupling 40 for a host pipe 100. In this embodiment, the coupling 40 is used to provide a branch line to the pipe 100 and as such, is formed intermediate the ends (101, 102) of the pipe 105. In the illustrated form, the coupling 40 forms a polymeric collar 41 which projects from the pipe surface. This collar 41 defines a central cavity 42 in which an aperture 104 in the underlying pipe wall is located. With this arrangement, a second pipe having a suitable coupling on its end can be connected into the pipe 100 at the coupling 40.

Whilst in one form the coupling 40 may be formed offsite, in an alternate arrangement the coupling may need to be made onsite on an already laid pipe. In that arrangement, the polymeric component 41 is moulded onto the pipe wall, and the aperture 104 is tapped into the pipe onsite.

FIG. 3 illustrates a further type of water infrastructure product, namely a water tank 300. In the embodiment of FIG. 3, the water tank 300 is formed with a cylindrical wall 301 which is made from a profiled sheet metal strip. Again this sheet metal strip may be sheet steel which incorporates a corrosion resistant metal coating and typically incorporate a polymeric coating. An example of a suitable PVC coated sheet steel strip is sold by the applicant under the trade mark AQUAPLATE™. The sheet metal strip typically has a gauge of between 0.5 mm to 1.6 mm and may be profiled with corrugations or ribs and the tank wall may be made from a spiral winding of the sheet strip or in a more conventional configuration, the tank wall is built up by a series of cylindrical panel elements which are disposed one on top of the other.

In the embodiment of FIG. 3, the tank incorporates a polymeric component 55 which is cast onto the bottom of the tank wall 302. This polymeric component forms part of a base assembly 303 for the tank 300.

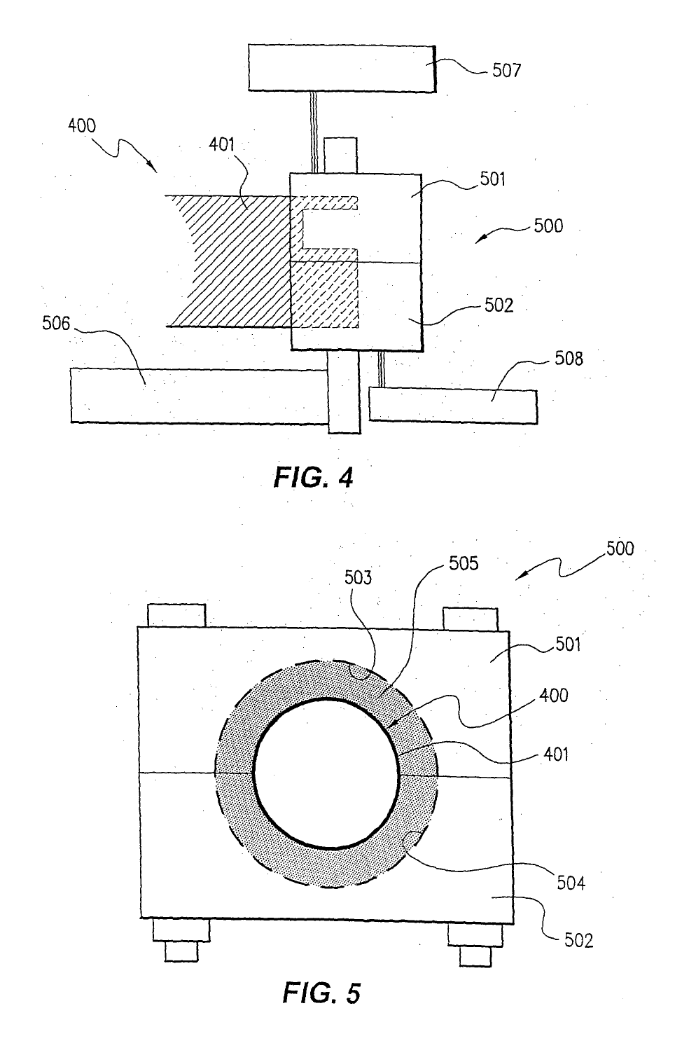

In each of the embodiments illustrated above, the polymeric components are cast directly onto the product section 100, 200 or 300. FIGS. 4 to 16 illustrate different processes for casting in more detail.

Turning firstly to FIGS. 4 and 5, to cast the components onto a product section 400, in a first embodiment a moulding apparatus 500 is provided which incorporates mould parts 501 and 502 which clamp around the product section 400. The mould parts 501, 502 each have an interior mould wall 503 and 504 which when clamped to the product section 400 form, in conjunction with an outer surface 401 of the host section, a closed cavity 505 in which the polymeric material can be introduced.

The apparatus 500 further comprises a feed assembly 506 for introducing the polymeric material into the mould cavity 505. This assembly is typically in the form of an a extruder/injector system which introduces the polymer material in a liquid form under relatively low pressure (typically in the order of 210 kpa-480 kpa) so as not to deform the product section 400. Furthermore, single or multiple injection paths may be used to combine the properties of one or more polymers or other extruded materials to create both a homogenous or heterogenous structures that have an influence upon the physical properties and economics of the final moulded component.

Typically injected polymeric material may be derived from resins associated with polyolefin, ethylene vinyl acetates, poly vinyl chloride, polypropylenes, polycarbonates, nylon and associated blends. These polymeric materials may in addition or alternatively comprise rubber related compounds and may or may not be reinforced by the addition of ceramic or glass beads, directional fibres nanoparticles (such as nanoclays), and/or solid inserts manufactured from polymer or metallic components. The composition of the polymeric material may vary as will be appreciated by persons skilled in the art.

To control the operating parameters of the moulding process, the host section 400 and/or the mould shells 501, 502 may be heated to aid the particular polymer flow characteristics. Typically this will be done via a mould heat apparatus 507. Further, these components may be selectively cooled (by apparatus 508) to control the material flow and shrinkage of the moulded component. In one form, the mould and/or the pipe is cooled to room temperature over a period, typically of less than 15 minutes. Further, a fluid seal may be formed between the mould as the section surface by rapid cooling of the polymeric material in the region of that join. Alternatively a fluid seal may be provided by the use of other sealing arrangements as will be described below.

In addition, gases and or other chemical blowing agents may or may not be added to the polymer material either at the time of formulation or at the point of injection of the polymer to the mould to increase the pressure within the mould to enable the polymeric material to fully take up the shape of the cavity and to control shrinkage of the moulded part and/or the specific filling characteristic of the polymers and the mould cavity.

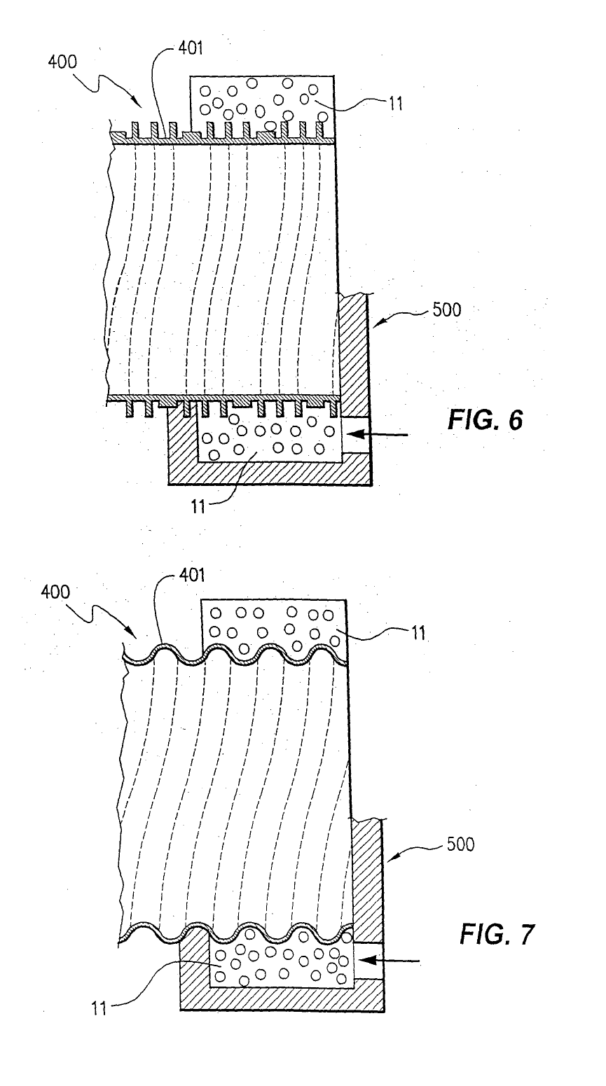

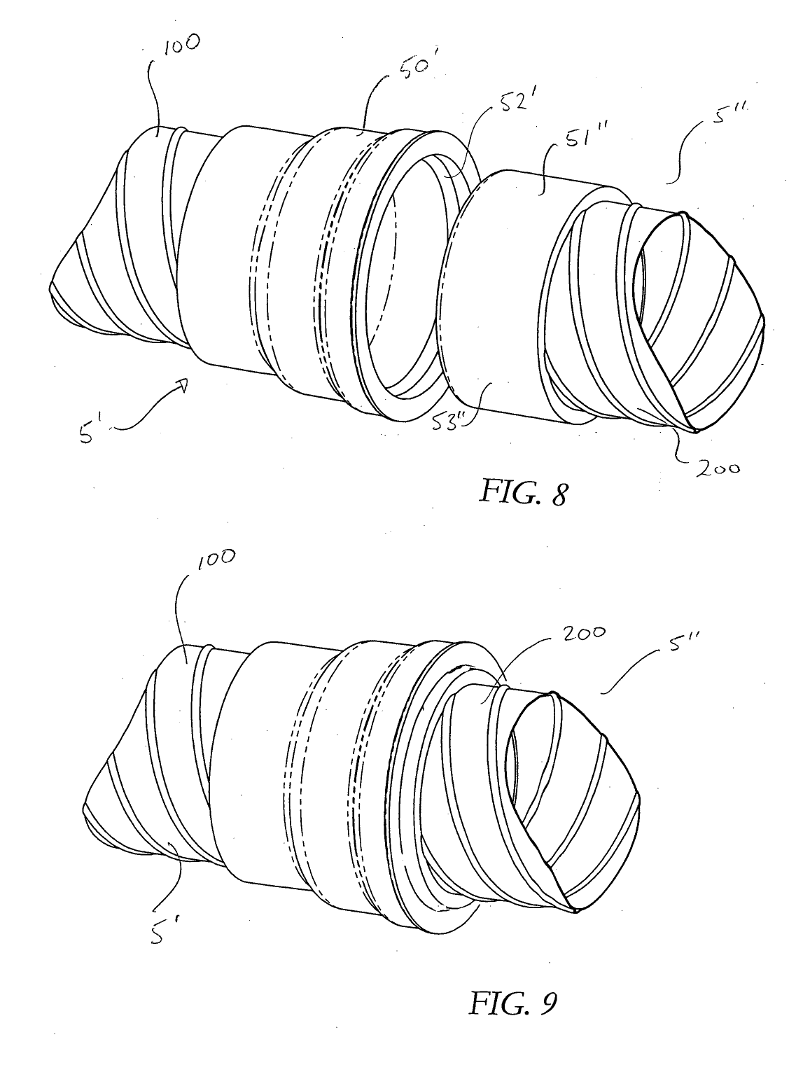

FIGS. 6 and 7 schematically illustrate the moulds 500 shown in the first embodiment when connected to an externally ribbed smooth bore steel pipe whereas in FIG. 7 the host section 400 is a corrugated pipe.

In view of the direct casting of the polymeric component 11 onto the host surface 401 it is possible for the component to precisely take up the shape of that surface so that it is intimately in contact with that surface substantially along the entire interface between those parts. This improves the effectiveness of the interface or joint between these parts to prevent fluid penetration and improves its mechanical strength.

In one form, by choosing appropriate materials, it is possible to achieve a strong bond between the polymeric component and the host section. In one form the polymeric material may bond directly onto a metal surface. Alternatively, the pipe may be pre-coated with a polymeric coating such as that described above so as to enable that coating to bond with the polymeric material of the component. In that arrangement, the coating may be heated to become tacky to assist in formation of the bond between the section and the component. Typically the coating is heated in the range of 90° to 180° and more preferably about 130°.

In addition, if the host section 400 has a profiled outer surface, as illustrated in FIGS. 6 and 7, then the casting of the polymeric components onto that surface provides a mechanical interference which both improves the strength of the connection and also creates a torturous path which can aid in inhibiting fluid penetration through the interface between the parts. This mechanical interference may be improved by the polymeric component shrinking during cooling after it is cast and by bonding on the polymeric coating.

By casting the components onto the host section, it can obviate or at least substantially reduce the need to further shape the components after they have been cast. However, it is to be appreciated that if some complex shapes are required, then some post forming may be necessary. However, in many instances no post forming will be required. This not only provides the advantage of simplifying the process for forming the components and also the equipment that is necessary, but also provides an arrangement where the components can be cast onsite. This is particularly advantageous in water infrastructure where new sections of channels or pipes may be need to be installed and/or new connections made.

Turning to FIGS. 11 to 13, a casting process and apparatus according to a second embodiment is disclosed. This casting process includes many of the steps of the earlier embodiment and in that respect, the disclosure above with reference to the first embodiment is equally applicable to the second embodiment. For example, the casting process is applied to the host section 400, which may or may not be profiled, with moulding apparatus 600 being clamped on the host section 400 to allow the casting of a polymeric component.

As shown schematically in FIG. 11, a male (spigot) end coupling 60 incorporates a first portion 61 which is disposed along the outer surface 401 of the host section 400 and an inner portion 62 which is disposed within the bore of the host section 400. The outer and inner portions (61, 62) of the coupling 60 are integrally formed and are each connected both at a terminal end 63 of the coupling 60 which projects beyond the end of the host section 400 as well as through holes 403 which are formed in the host section 400.

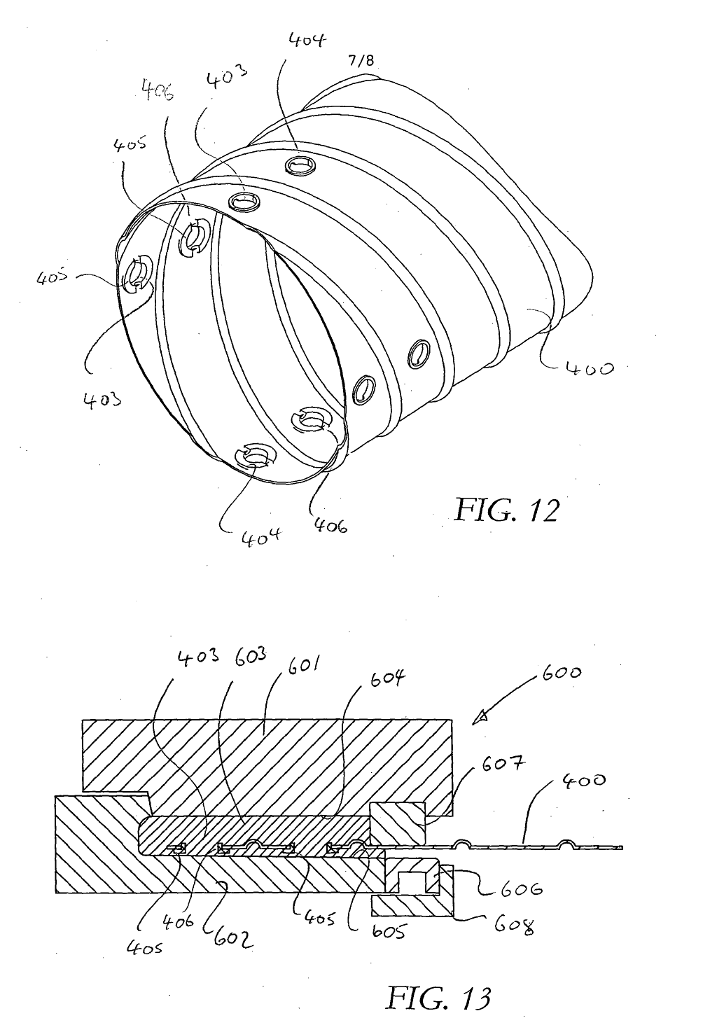

FIG. 12 illustrates the host section prior to casting of the component 60 onto the section end. The host section 400 includes a plurality of the holes 403 which are spaced evenly about the section 400. Typically these holes are punched into the host section and allow the fluid polymeric material introduced in the casting process to be equally presented to both internal and external surfaces of the section 400 so as to allow formation of both the outer and inner (61, 62) portions of the coupling 60.

After formation of the holes 403 within the host section 400, stand off spacers 404 may be inserted into the holes 403. The stand off spacers are typically made from a suitable polymer and provide an access path for the fluid polymer introduced into the cavity of the mould 600. The spacers 404 also include legs 405 which bear against the mould 600 so as to assist in maintaining a constant distance between the host section 400 and the mould 60 so as to correctly locate the host section within the mould 600 as will be discussed below.

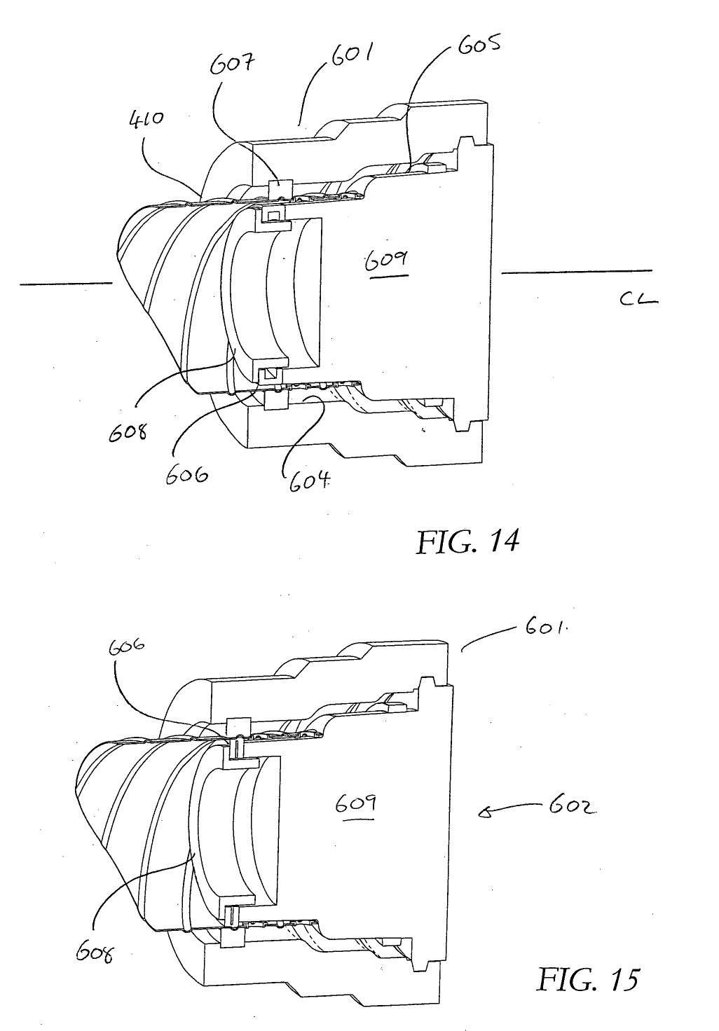

FIG. 13 illustrates the mould set up generally, whilst FIGS. 14 and 15 illustrate the construction of one form of the moulds in more detail. Turing firstly to FIG. 13, the mould 600 includes an outer mould component 601 and an inner mould component 602. The mould cavity 603 which is used to produce the coupling 60 is defined by a cavity part formed by inner surface 604 of the mould component 601 and a cavity part formed by inner surface 605 of the inner mould component 602. In this way, the host section 400 is disposed within the cavity 603 in spaced relation from the respective inner surfaces 604, 605 of the mould component 601, 602. As mentioned above, to maintain the position of the host section 400 within the mould, the legs 405 of the spacers 404 are arranged to bear against at least one of the inner mould surfaces (in the illustrated form being the surface 605). To ensure that the polymeric material introduced into the cavity 603 is able to fully fill the cavity, the legs 405 of the spacers 404 do not extend around the entire circumference of the respective spacers but rather cut outs 406 are provided which provide access ports and facilitate flow of the polymer material around those spacers to fully fill the cavity 603.

Upon introduction of the polymeric material into the cavity 603 the material is able to flow through the apertures and around the host section 40. In this way the pressure on opposing sides of the host section is substantially equalised thereby reducing the likelihood of any deformation of the thin walled host section 400. As such, the pressure at which the polymeric material in liquid form is introduced into the cavity may be greater than in the earlier embodiment. Whereas in the first embodiment the pressure was typically no greater than 480 kpa, in the second embodiment, pressures in the order of 800 kpa or even greater can be used without risk of deformation of the host section 400. A further advantage of the moulding process according to the second embodiment is that the resultant intrusion of the polymer through the holes 403 also provides a positive locking of the moulded coupling 60 onto the post section 400.

During the casting process according to the second embodiment, the same types of polymeric material may be used as disclosed in the earlier embodiment. Furthermore the operating parameters of the moulding process are equally applicable to this second embodiment.

FIGS. 14 and 15 illustrate the construction of the mould 600 in more detail. Turning firstly to FIG. 14, the outer mould 601 locates around the host pipe 400 and is typically formed in two parts (not shown) which are movable between an open condition which allows the host pipe 400 to locate over the inner mould component to a closed condition as illustrated in FIGS. 14 and 15 wherein the mould parts of the outer mould clamp around the end of the host pipe 400.

The mould 600 further includes a sealing arrangement that is engagable with the inner and outer surfaces of the pipe so as to prevent moulding material introduced into the cavity 603 to egress from that cavity. In this respect, the inner mould 602 includes a first seal 606 and the outer mould component 601 includes a second seal 607 which are associated with the respective outer mould parts.

The first seal 606 is disposed at the end of the inner surface 605 which defines the inner wall of the cavity 603. The seal is located between an end piston 608 which is movable relative to the main part 609 of the inner mould component 602 so as to be able to move the seal from a retracted position as shown in FIG. 14 to an extended condition as shown in FIG. 15. In the extended condition the seal 606 is caused to be compressed by movement of the piston 608 towards the main part 609 of the inner mould component 602 which in turn cause radial expansion (relative to the axis CL of the inner mould component). This causes the seal 606 to bias against the inner surface of the host section 400 thereby providing a fluid seal along that inner surface.

An advantage of the first seal arrangement on the inner mould component is that it facilitates movement of the host section 400 on and off the inner mould component 602. In use relative movement occurs between the pipe and the inner mould component 602 in the direction of the mould axis CL so that the host pipe 400 locates over the main part 609 of the inner mould. This relative movement occurs whilst the seal 606 is in its retracted condition thereby ensuring that the seal does not inhibit this relative movement. Once in position the seal can then be moved to its expanded position (as shown in FIG. 16) by the axial movement of the piston 608.

The second seal 607 in the illustrated form is in the form of a deformable polymeric material which is arranged to conform to the profile of the outer surface of the host section when the outer mould 601 is moved from its open condition to its closed condition. In use the seal 607 is in two parts with a respective part located within a recess 610 formed in each part of the outer mould 601. In particular the deformable seal 607 is able to accommodate the stiffening ribs 410 formed on the outer surface of the pipe. In this way an effective fluid seal can be formed along this interface between the outer mould component 601 and the outer surface of the pipe 400.

In use the moulding material is introduced into the cavity 603 through an inlet port (not shown) so as to enable the cavity 603 to be filled. The air from the cavity 603 is able to be vented through an outlet port (not shown). Once the component has been cast on the section 400 and once the coupling has gone through a cooling cycle, the outer mould is opened. The inner seal 606 is also decompressed by movement of the piston 608 away from the main part 609 of the inner mould component 602 thereby allowing the seal to move to its retracted position. The pipe can then be ejected from the inner mould component 602 and a new pipe can then be inserted into the mould for casting of the component onto that host section.

In one variation of the above arrangement, one of the inner, or outer, mould component does not incorporate a cavity but rather is provided merely to support the host pipe during the casting process. In this arrangement, there is no requirement to balance fluid pressure on either sides of the pipe 400. Rather the body is supported during casting by one of the inner or outer core components which acts as a backing support for the body.

Accordingly, a mould according to at least one form described above may have the following advantages:
1. the mould allows for direct casting of polymeric components onto a host member. In particular the mould is able to engage with a portion of a host body so as to allow that direct casting to occur whilst allowing a remaining portion of the body to project from the mould. In this way the mould is ideally suited to casting components on elongated members such as pipes for water infrastructure;
2. the mould is able to create effective seals on both smooth wall and profiled surfaces. In specific embodiments the mould is arranged to engage with a pipe incorporating external ribs;
3. the mould is able to provide support for the host member. This is advantageous to thin-walled structures. This support may be achieved by direct engagement of a component of the mould with a surface of the host member opposite to the surface on which the polymeric component is cast and/or, the mould may provide an arrangement where fluid pressure is provided on both sides of the surface;
4. the mould provides configurations to allow easy engagement and disengagement with the host member particularly where that host member is hollow and in the form of a pipe or the like.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Variations and modifications may be made to the parts previously described without departing from the spirit or ambit of the invention.

1-28. (canceled)

29. A mould for casting a component onto a body having opposite sides, the mould comprising first and second mould parts arranged to be disposed on respective ones of the opposite sides of the body, and at least one of the parts defining at least a portion of a mould cavity that is in communication with the body so that the component is able to be cast on at least one of the opposite sides of the body, wherein when the mould is disposed on the body, a passage is formed in the mould to enable the body to extend from the mould.

30. A mould according to claim 29 wherein each of the first and second mould parts define a portion of the mould cavity so that the component is able to be cast on both of the opposite sides of the body.

31. A mould according to claim 29, wherein the mould is arranged to provide support for the body during casting of the component.

32. A mould according to claim 31, wherein the mould is arranged to enable fluid pressure to be applied to both sides of the body so as to support the body during casting of the component.

33. A mould according to claim 31, wherein one of the first and second mould parts is arranged to provide a support surface for the body whilst the component is being cast on the body.

34. A mould according to claim 29, wherein the first and second mould parts are separate and are arranged to engage and when so engaged form a common cavity in which the portion of the body is arranged to be received.

35. A mould according to claim 29, wherein the body is a hollow section and one of the opposite sides is an outer surface of the body and the other opposite side defines an inner surface of the body and one mould part forms an inner mould component disposed on the inner surface whilst the other mould part forms an outer mould component disposed on the outer surface.

36. A mould according to claim 29, further comprising a sealing arrangement arranged to engage with the body and being operative to provide a fluid seal between the body and the mould so as to prevent moulding material introduced into the mould cavity to egress from the cavity.

37. A mould according to claim 35, wherein the sealing arrangement includes a seal that is movable between a retracted and an extended condition, wherein the seal is arranged to be moved from its retracted to its extended condition to affect a fluid seal with the body.

38. A mould according to claim 37, wherein the mould further comprises an actuator operative to move the seal between its retracted and extended condition.

39. A mould according to claim 37, wherein on moving the seal from its retracted to its extended condition, the actuator is operative to compress the seal in a first direction so as to cause the seal to extend in a second direction generally normal to the first direction.

40. A mould for casting a component onto an body, the mould defining a mould cavity and incorporating a sealing arrangement, wherein a portion of the body is arranged in communication with the mould cavity and the sealing arrangement is arranged to engage with the body and is operative to provide a fluid seal between the body and the mould so as to prevent moulding material introduced into the cavity to egress from the cavity, the sealing arrangement including a first seal that is movable from a retracted to an extended condition to affect a fluid seal with the body, wherein the mould further comprises an actuator operative to move the first seal between its retracted and extended condition and wherein on moving the seal from its retracted to its extended condition, the actuator is operative to compress the seal in a first direction so as to cause the seal to extend in a second direction generally normal to the first direction.

41. A mould according to claim 40, wherein the sealing arrangement includes a seal that is deformable and is arranged to conform to the profile of the body surface.

42. A mould according to claim 40, wherein when the mould is disposed on the body, a passage is formed in the mould to enable the body to extend from the mould, the body having opposite sides and the sealing arrangement is operative to provide a fluid seal between both the opposite sides and the mould.

43. A mould according to claim 40, wherein the body is formed as a hollow section and the mould includes an inner and an outer mould component, the inner and outer components each defining a part of the mould cavity and arranged to be disposed on opposite sides of the body.

44. A mould according to claim 43, wherein the sealing arrangement is associated with both the inner and outer mould components so as to be operative to provide a fluid seal between both opposite sides of the body and the mould.

45. A mould according to claim 43, wherein the inner and outer mould components engage and when so engaged form a common cavity in which the portion of the body is arranged to be received.

46. A mould according to claim 43, wherein the sealing arrangement includes a second seal wherein respective ones of the first and second seals are disposed on respective ones of the inner and outer mould components.

47. A mould according to claim 46, wherein at least one of the mould components having a said first seal is caused to move radially relative to a mould axis on movement from its retracted to its extended condition.

48. A mould according to claim 47, wherein the at least one mould component is arranged to be moved into and out of register with the body by relative movement therebetween in the direction of the mould axis, and wherein such relative movement occurs when the seal is in the retracted condition.

49. A mould according to claim 46, wherein the first seal is disposed on said inner mould component.

50. A mould according to claim 46, wherein said second seal is deformable so as to conform to the profile of the body surface.

51. A mould according to claim 50, wherein the second seal is deformable and the outer mould component is in the form of first and second outer mould parts that are movable with respect of each other so as to open to receive the body portion and to close to bias the second seal into contact with the body surface so as to cause the second seal to conform to the surface of the body.

52. A mould according to claim 35, wherein the body is in the form of a pipe and wherein the inner mould component is locatable within the pipe and the outer mould component is arranged to clamp around the exterior of the pipe.

53. A process of sealing a mould part to the surface of a body comprising the steps of
moving one or both of the mould part and the body into register with the other; and
compressing a seal on the mould part to move the seal from a retracted position to an extended position so as to form a fluid seal between the mould part and the body.

54. A process according to claim 53, wherein the seal is caused to be compressed in a first direction so as to cause the seal to extend in a second direction generally normal to the first direction.

55. A mould according to claim 43, wherein the body is in the form of a pipe and wherein the inner mould component is locatable within the pipe and the outer mould component is arranged to clamp around the exterior of the pipe.
